(19) United States
(12) Patent Application Publication
(10) Pub. No.: US 2026/0213986 A1
(43) Pub. Date: Jul. 23, 2026

(54) PRESERVING DIFFERENTIAL PRIVACY

(71) Applicant: Nokia Solutions and Networks Oy, Espoo (FI)

(72) Inventor: Borzoo RASSOULI, Stuttgart (DE)

(21) Appl. No.: 19/439,612

(22) Filed: Jan. 5, 2026

(30) Foreign Application Priority Data
Jan. 22, 2025 (FI) 20255037

(51) Int. Cl. H04L 27/26; H04W 12/02

(52) U.S. Cl. CPC H04L 27/26025; H04W 12/02

(57) ABSTRACT

Provided is a method comprising checking if a privacy requirement has to be fulfilled for a transmission of a message comprising plural symbols on a channel; transmitting each of the symbols of the message over the channel at a respective time according to a predefined timing in response to checking that the privacy requirement has not to be fulfilled or transmitting at least one of the symbols of the message over the channel with a respective time offset τ*T relative to the respective predefined time in response to checking that the privacy requirement has to be fulfilled, wherein T is a time delay between transmissions of subsequent symbols of the message on the channel according to the predefined timing and wherein τ is larger than 0 and smaller than 1.

### TECHNICAL FIELD

The present disclosure relates to preserving differential privacy.

Abbreviations

| | |
|---|---|
| 3GPP | 3^{rd} Generation Partnership Project |
| 4G/5G/6G | 4^{th}/5^{th}/6^{th} Generation |
| ADC | Analogue to Digital Converter |
| AWGN | Additive White Gaussian Noise |
| BAC | Binary Asymmetric Channel |
| BSC | Binary Symmetric Channel |
| CCPA | California Consumer Privacy Act |
| DMRS | Demodulation Reference Signal |
| DP | Differential Privacy |
| GDPR | General Data Protection Regulation |
| gNB | Base Station |
| i.i.d. | independent and identically distributed random variables |
| ISI | Intersymbol Interference |
| MAP | maximum a posteriori |
| ML | maximum likelihood |
| pdf | probability density function |
| PISI | Privacy by ISI |
| PSNR | Privacy by SNR |
| RC | raised cosine |
| RF | Radio Frequency |
| RRC | root-raised-cosine |
| SNR | Signal to Noise Ratio |
| SRS | Sounding Reference Signal |

### BACKGROUND

Differential privacy (DP) is an approach for providing privacy while sharing information about a group of individuals, by describing the patterns within the group while withholding information about specific individuals. DP was originally proposed to give formal guarantee of privacy in case commonly used anonymization techniques (such as k-anonymity and I-divergence) are not sufficient. Nowadays, for example, United States Census Bureau has adopted DP in privacy protection and big players in the information technology field, like Google and Apple, heavily rely on it. DP can also help to comply with data privacy regulations such as GDPR and CCPA.

This is done by making random small changes to individual data that do not (or hardly) change the statistics of interest. Thus, the data cannot be used to infer much about any individual. Another way to describe differential privacy is as a constraint on the algorithms used to publish aggregate information about a statistical database which limits the disclosure of private information of records in the database. Roughly, an algorithm is differentially private if an observer seeing its output cannot tell whether a particular individual's information was used in the computation.

### SUMMARY

It is an object to improve the prior art.

According to a first aspect, there is provided an apparatus, comprising
means for checking if a privacy requirement has to be fulfilled for a transmission of a message comprising plural symbols on a channel;
means for transmitting each of the symbols of the message over the channel at a respective time according to a predefined timing in response to checking that the privacy requirement has not to be fulfilled; wherein
the means for transmitting is configured to transmit at least one of the symbols of the message over the channel with a respective time offset τ*T relative to the respective predefined time in response to checking that the privacy requirement has to be fulfilled;
T is a time delay between transmissions of subsequent symbols of the message on the channel according to the predefined timing; and
τ is larger than 0 and smaller than 1.

τ may be equal to or larger than 0.01 and equal to or smaller than 0.99.

In the apparatus, the following relationship may be fulfilled:

$$τ = {sinc}^{- 1} ( \frac{1}{2} ( 1 - \frac{{Q}^{- 1} ( {e}^{{ϵ}_{0}} Q ( \sqrt{SNR} ) )}{\sqrt{SNR}} ) ) ,$$

wherein e is the Napier number, ϵ₀ denotes the privacy requirement, SNR denotes the signal-to-noise ratio of the channel, and Q(\sqrt{SNR}) is a crossover probability of the channel at the signal to noise ratio SNR.

The means for transmitting may be configured to transmit each of the symbols of the message over the channel with a respective time offset τ*T relative to the respective predefined time in response to checking that the privacy requirement has to be fulfilled.

τ may have a same value for the transmission of each of the symbols of the message.

The apparatus may further comprise
means for determining, for each of the symbols of the message, a respective value of τ by a random function.

The random function may have a probability distribution such that the privacy requirement is fulfilled for every arbitrary distribution of values of the symbols of the message.

The apparatus may further comprise
means for inhibiting encoding of the symbols for the transmission of the symbols on the channel.

The apparatus may further comprise
means for encoding the symbols symbol-per-symbol for the transmission of the symbols on the channel.

According to a second aspect of the invention, there is provided a method, comprising
checking if a privacy requirement has to be fulfilled for a transmission of a message comprising plural symbols on a channel;
transmitting each of the symbols of the message over the channel at a respective time according to a predefined timing in response to checking that the privacy requirement has not to be fulfilled; wherein
transmitting at least one of the symbols of the message over the channel with a respective time offset τ*T relative to the respective predefined time in response to checking that the privacy requirement has to be fulfilled;
T is a time delay between transmissions of subsequent symbols of the message on the channel according to the predefined timing; and
τ is larger than 0 and smaller than 1.

τ may be equal to or larger than 0.01 and equal to or smaller than 0.99.

In the method, the following relationship may be fulfilled:

$$τ = {sinc}^{- 1} ( \frac{1}{2} ( 1 - \frac{{Q}^{- 1} ( {e}^{{ϵ}_{0}} Q ( \sqrt{SNR} ) )}{\sqrt{SNR}} ) ) ,$$

wherein e is the Napier number, ϵ₀ denotes the privacy requirement, SNR denotes the signal-to-noise ratio of the channel, and Q(\sqrt{SNR}) is a crossover probability of the channel at the signal to noise ratio SNR.

In the method, the means for transmitting may be configured to transmit each of the symbols of the message over the channel with a respective time offset τ*T relative to the respective predefined time in response to checking that the privacy requirement has to be fulfilled.

τ may have a same value for the transmission of each of the symbols of the message.

The method may further comprise
means for determining, for each of the symbols of the message, a respective value of τ by a random function.

The random function may have a probability distribution such that the privacy requirement is fulfilled for every arbitrary distribution of values of the symbols of the message.

The method may further comprise
means for inhibiting encoding of the symbols for the transmission of the symbols on the channel.

The method may further comprise
means for encoding the symbols symbol-per-symbol for the transmission of the symbols on the channel.

The method may be a method of preserving privacy.

According to a third aspect, there is provided a computer program product comprising a set of instructions which, when executed on an apparatus, is configured to cause the apparatus to carry out the method according to the second aspect. The computer program product may be embodied as a computer-readable medium or directly loadable into a computer.

According to some example embodiments, at least one of the following advantages may be achieved:
another method to preserve privacy is provided;
may be better than other methods to preserve privacy;
level of achieved privacy may be adjustable;
receiver need not be modified;
dynamic range of the amplifier at the receiver need not be unusual large for strict privacy requirements;
desired privacy level may be achieved even if the channel has low channel noise.

### BRIEF DESCRIPTION OF THE DRAWINGS

Further details, features, objects, and advantages are apparent from the following detailed description of the preferred example embodiments which is to be taken in conjunction with the appended drawings, wherein:

FIG. 1 illustrates a binary (symmetric or asymmetric) channel;

FIG. 2 illustrates a transmitter according to some example embodiments;

FIG. 3 illustrates a method according to some example embodiments;

FIG. 4 shows an empirical distribution of ISI at SNR=0 dB and

$$τ = \frac{1}{2} ;$$

FIG. 5 illustrates Privacy loss vs. time offset at SNR=0 dB according to some example embodiments;

FIG. 6 shows time offset vs. the privacy loss at SNR=0 dB and 10 dB, respectively, according to some example embodiments;

FIG. 7 illustrates utility vs. privacy trade-off for PISI according to some example embodiments and PSNR;

FIG. 8 illustrates privacy loss vs. the tuning parameter of the beta distribution for τ at SNR=0 dB according to some example embodiments;

FIG. 9 illustrates privacy loss vs. time offset with RRC pulse shape and SNR=0 dB;

FIG. 10 shows an apparatus according to an example embodiment;

FIG. 11 shows a method according to an example embodiment; and

FIG. 12 shows an apparatus according to an example embodiment.

### DETAILED DESCRIPTION OF CERTAIN EXAMPLE EMBODIMENTS

Herein below, certain example embodiments are described in detail with reference to the accompanying drawings, wherein the features of the example embodiments can be freely combined with each other unless otherwise described. However, it is to be expressly understood that the description of certain example embodiments is given by way of example only, and that it is by no way intended to be understood as limiting the disclosure to the disclosed details.

Moreover, it is to be understood that the apparatus is configured to perform the corresponding method, although in some cases only the apparatus or only the method are described.

### Differential Privacy

The concept of ε-differential privacy provides a mathematical definition for the privacy loss associated with any data release drawn from a statistical database. Here, the term statistical database means a set of data that are collected under the pledge of confidentiality for the purpose of producing statistics that, by their production, do not compromise the privacy of those individuals who provided the data.

The intuition for a definition of ε-differential privacy is that a person's privacy cannot be compromised by a statistical release if their data are not in the database. Therefore, with differential privacy, the goal is to give each individual roughly the same privacy that would result from having their data removed. That is, the statistical functions run on the database should not overly depend on the data of any one individual.

The level of privacy ε-differential privacy is defined by the value of E. The larger the value of E is, the higher is the risk that privacy may be violated. Two data sets D₁ and D₂ are said to be neighbors (adjacent) if they differ in only one data entry (i.e., the data of an individual). Let ε≥0. An algorithm/mechanism [symbol] , which is a random mapping in general, is said to be ε-differential private if

$$Pr ( 𝒜 ( {D}_{1} ) ∈ 𝒮 ) \leq {e}^{ε} Pr ( 𝒜 ( {D}_{2} ) ∈ 𝒮 ) ,$$

for all subsets S of output (also called “image”) of [symbol] and all adjacent datasets D₁ and D₂. Here, e is the Napier number (also called Euler number), and Pr the probability function.

The smaller the ε, the harder it is to distinguish whether D₁ or D₂ has generated the output (image) of the algorithm [symbol] , which in turn, makes the presence of an individual less likely to be noticed, since D₁ or D₂ differ in only one entry. Therefore, by lowering ε, the algorithm becomes more privacy-preserving. As a result, ε is sometimes called the privacy loss.

### Counting Query

Counting queries over tabular data are one of the most common types of queries, which have the form “how many rows in the database have the property X?” For example, each row could correspond to a survey respondent, and the property X could be “replied ‘yes’ to the survey”. As another example, each row could correspond to an individual patient, and the property X could be “being tested positive for a certain disease.” This type of query is widespread in practice. For example, more than half of queries written at Uber in 2016 were counting queries.

In the context of counting problems, the output of a query is an integer value, and since two neighboring datasets will have counts that differ by at most one, the adjacency constraint in the definition of differential privacy maps to the adjacency of integer numbers. In other words, adjacent numbers must be made as indistinguishable as required depending on the choice of ϵ.

### Binary Asymmetric Channel (BAC)

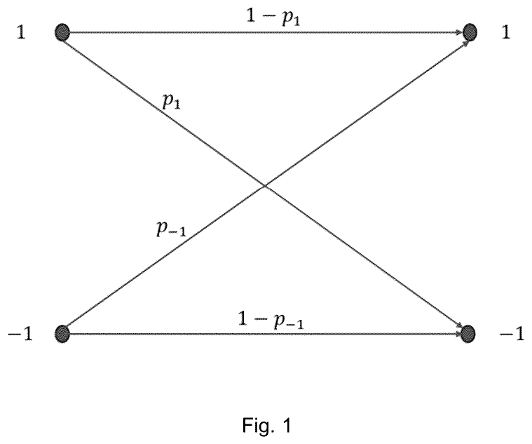

A binary asymmetric channel is a binary-input binary-output random mapping. Denoting the input and output of this channel by +1 and −1, this channel is shown as BAC(p₋₁,p₁), where p₋₁, p₁ denote the probability of a bit flip when the input is −1 or 1, respectively. An illustrative representation of this channel is provided in FIG. 1. On the left are shown the two possible input values 1 and −1, on the right are shown the two possible output values 1 and −1. The arrows connecting each of the input values with each of the output values are labelled with the probability that the output value at the end of the arrow is obtained when the input value at the beginning of the arrow is input into the channel.

It may be calculated that the privacy loss of bit transfer over this channel is given by

$$ϵ = ln max \{ \frac{{p}_{1}}{1 - {p}_{- 1}} , \frac{1 - {p}_{- 1}}{{p}_{1}} , \frac{{p}_{- 1}}{1 - {p}_{1}} , \frac{1 - {p}_{1}}{{p}_{- 1}} \}$$

If p₋₁=p₁=0, there is no error in transmission, which results in ϵ=¢, i.e., infinite privacy loss in the context of DP. On the other hand, if p₋₁+p₁=1, we get the other extreme, i.e., no privacy loss (ϵ=0), since in this case, the distribution of the output does not change by changing the input, or in other words, the output is statistically independent of the input. (To put it in a practical perspective, assume that {−1,1} denote the output of a query applied to a specific row of a dataset, like, “Does the person in row 1 have cancer?” with 1 denoting “yes” and −1, “no”. Alternatively, {−1,1} could denote the one-bit quantized version of some sensitive information.)

Finally, when p₋₁=p₁, this channel is referred to as the binary symmetric channel (BSC), which is one of the simplest noisy channels often used, since many problems in communication theory can be reduced to a BSC.

### Additive White Gaussian Noise (AWGN) Channel

An AWGN channel is the basic model of a communication system, which is explained here briefly through a simplified (yet informative) example, as follows. The baseband signal at the transmitter is given by

$$X ( t ) = {\sum }_{n = - ∞}^{+ ∞} {B}_{n} g ( t - nT )$$

where {Bₙ} and g(.) denote the i.i.d. binary message sequence and the sinc pulse, respectively. Therefore, every T seconds, one bit is transmitted, where the value of T depends on the bandwidth of the channel.

Denoting the additive noise by W(t), the receiver samples the received signal Y(t)=X(t)+W(t) every T seconds to obtain Yᵢ=g(0)Bᵢ+N, with N denoting zero-mean Gaussian noise, as the input of the decoder. The latter outputs an estimate B̅, ∈{−1,1} with probability of error given by pₑ=Pr(Bₗ≠\hat{B}ₜ).

### Time Synchronization Between Transmitter and Receiver

In many wireless and wired communication systems, the time at receiver and transmitter is synchronized such that the receiver knows when to expect a transmission from the transmitter. Examples of such synchronization procedures are as follows:

### 1. Wireless Time Synchronization:

Time synchronization in wireless communication is a critical aspect of ensuring that the receiver correctly samples and decodes the transmitted data. One common method to achieve time synchronization is the use of pilot tones or training sequences that are transmitted along with the data. The receiver can then use these known symbols to estimate the time offset between the transmitter and receiver. Time synchronization techniques, such as symbol synchronization and frame synchronization, help align the receiver's clock with the transmitter's clock.

### 2. Wired Time Synchronization:

This is especially important in systems like Ethernet, where clock synchronization is achieved by passing a reference clock signal along with the data stream. In synchronous communication protocols (e.g., Inter-Integrated Circuit (I2C), Serial Peripheral Interface (SPI)), the clock signal is shared between devices to ensure that data is transmitted and received at the correct times.

### Intersymbol Interference (ISI)

Intersymbol interference (ISI) is a form of distortion of a signal in which one symbol interferes with the others. There could be various causes for ISI. For instance, in the above AWGN example, if the receiver, instead of every T seconds, samples the signal every 0.9T seconds, there will be a third additive term in Yᵢ caused by the other bits, i.e., B′ₙs(n≠i), due to ISI. This new additive term can be regarded as data-dependent noise contrary to the original Gaussian noise of the channel (N) which is independent of the data. This undesired phenomenon makes the communication less reliable, and one way to alleviate ISI is the use of equalizers at the receiver side.

Some example embodiments exploit ISI to preserve differential privacy of a communication between transmitter and receiver.

Assume that binary i.i.d. messages are to be sent over an AWGN channel, i.e.,

$$X ( t ) = {\sum }_{n = - ∞}^{+ ∞} {B}_{n} g ( t - nT )$$

Furthermore, assume that some level of privacy protection is required for these messages. In the context of DP, the requirement is to restrict the privacy loss of this transmission below a given threshold ϵ₀.

One way to address this requirement in the literature is to lower the signal to noise ratio (SNR), which in turn, increases the error probability. This increase in the error is the price paid for the protection of privacy. However, in practice, the SNR cannot be lowered arbitrarily due to the hardware limitation, e.g., the dynamic range of RF amplifiers. More specifically, in high privacy regime, i.e., low privacy loss, this approach requires low values of SNR which can result in nonlinear distortion in the standard RF amplifiers.

According to some example embodiments, at least one symbol is transmitted with an offset (a time offset) of τT relative to the predefined time for the transmission of the symbol. For example,

$$τ = {sinc}^{- 1} ( \frac{1}{2} ( 1 - \frac{{Q}^{- 1} ( {e}^{{ϵ}_{0}} Q ( \sqrt{SNR} ) )}{\sqrt{SNR}} ) )$$

where SNR denotes the signal to noise ration, ϵ₀ is the required privacy level, and Q(\sqrt{SNR}) is a crossover probability of the channel at the signal to noise ratio SNR, which are explained in detail below. According to some example embodiments, τ has a value larger than 0 and smaller than 1 (the values of 0 and 1 are excluded). By the introduction of this time offset, ISI distorts the received signal to the point of satisfying the desired level of privacy protection.

In some example embodiments, the lower limit of the value of τ may be 0.01, or 0.05, or 0.1.

In some example embodiments, the upper limit of the value of τ may be 0.99, or 0.95, or 0.9.

Typically, each of the symbols of a message is transmitted with a respective time offset of T relative to the predefined time for the transmission of the symbol. The time offset may be the same for all the symbols of a message or different for different symbols. For example, for each of the symbols, the respective time offset may be determined by a random function.

In some example embodiments, the transmission of at least one of the symbols may be shifted by a time offset if a privacy requirement has to be fulfilled. In some example embodiments, the transmitter transmits each of the symbols with a respective time offset if a privacy requirement has to be fulfilled. If a privacy requirement has not to be fulfilled, each of the symbols of the message is transmitted at the respective predefined time, without adding a time offset.

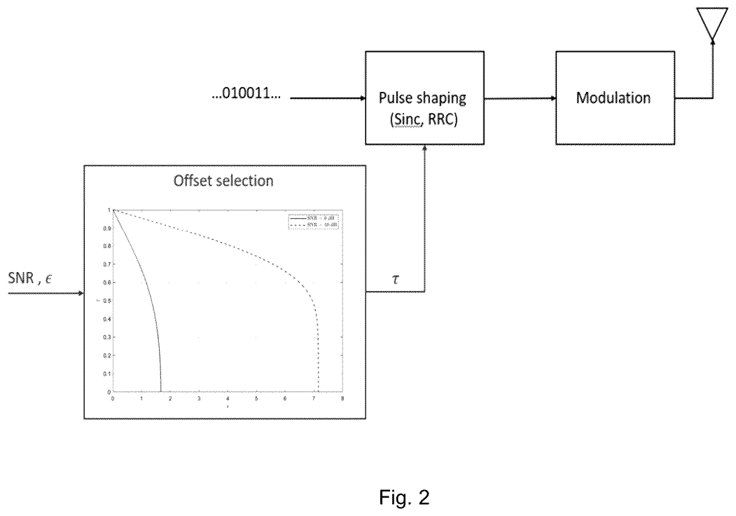

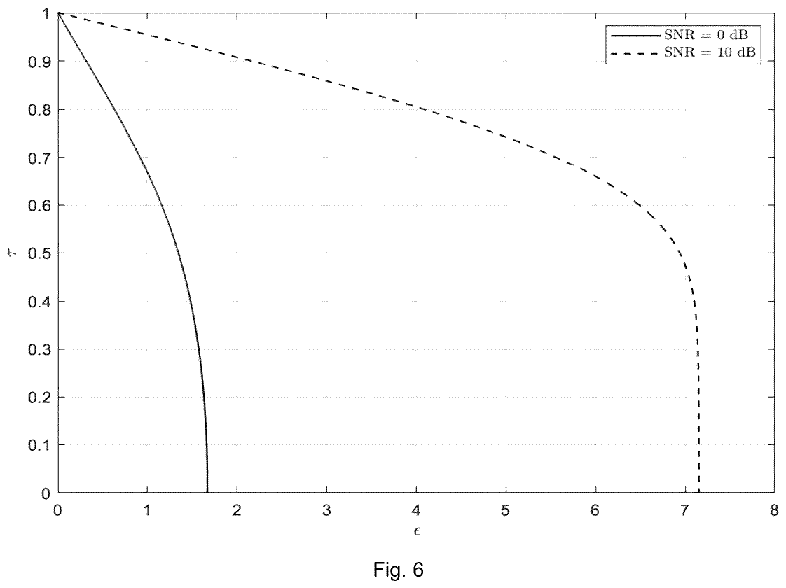

FIG. 2 shows a transmitter according to some example embodiments. The input message (stream of symbols like the bitstream shown in FIG. 2) goes through a pulse shaping component. Therein, if a privacy requirement has to be fulfilled, the transmission is shifted by a time offset τT, but if a privacy requirement has not to be fulfilled, the transmission is not shifted by the time offset. The value of τ may be determined based on SNR of the channel and the privacy requirement ϵ₀ (denoted as ϵ in FIG. 6). The pulse shaped signal is provided to a modulation unit and the modulated signal is transmitted to the receiver.

The receiver may be a conventional receiver which assumes that the symbols are received at the predefined (receiver) timing. Thus, at the receiver, some ISI is produced if the symbols are transmitted with the time offset relative to the predefined (transmitter) timing.

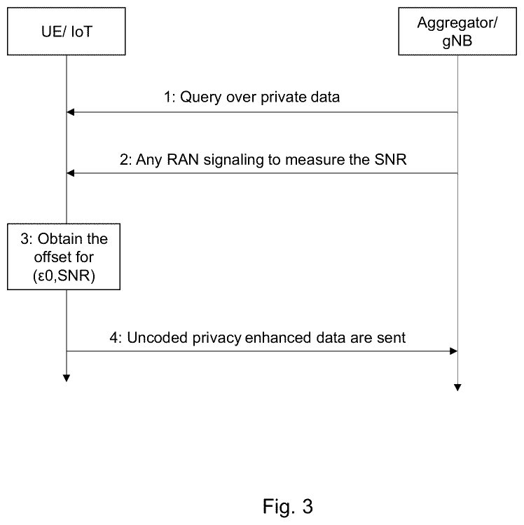

FIG. 3 shows a method according to some example embodiments. In the example of FIG. 3, the UE (such as an IoT device) is considered as the transmitter, and an aggregator, such as a gNB) is considered as the receiver. The actions in FIG. 3 are as follows:
1. The receiver issues a query to the transmitter to provide some data. At the transmitter, a privacy requirement exists for these data.
2. The transmitter uses any RAN signaling (typically based on a reference signal such as DMRS or SRS), to estimate the SNR to the receiver requesting the data.
3. Based on the privacy requirement and SNR, the transmitter determines the time offset to be applied to the transmission of the data.
4. The transmitter transmits the data, wherein the symbols are transmitted with the determined time offset. Typically, the data are not encoded.

For the explanation of this method, first two assumptions are made: 1) the messages are i.i.d., and 2) the receiver is unaware that the transmitter applies a time offset, or at least unaware about the value of the time offset. In the end of the explanation, an example embodiment is described where the second assumption may be omitted. The first assumption is made to allow a calculation of the required value of τ to achieve a desired value of the privacy level E, as outlined below. However, the method according to some example embodiments is also applicable to messages not being i.i.d. if the time offset τ*T, τ∈]0,1 [) produces some ISI. However, for such messages, in general it might not be possible to calculate a value of τ to achieve a desired value of the privacy level ϵ.

Some example embodiments employ ISI in a controlled manner as a mechanism for enhancing/preserving privacy in communication systems. This approach is distinct from previous strategies that predominantly relied on external noise sources or data masking techniques. This method offers an alternative solution to the challenge of privacy-aware communications in wired networks or wireless networks.

More specifically, since the transmitter introduces a deliberate deterministic or random time offset to the signal, at the receiver each received symbol will be impaired by interference from its preceding/proceeding symbols. This impairment, which can be regarded as data-dependent additive noise, protects the privacy of information by introducing error.

The methods that provide privacy by utilizing the channel noise might fail when the channel is already in good condition, i.e., low noise. However, the method according to some example embodiments continues to work even if the channel is in a good condition. Furthermore, since the way that the data are blurred by the interference depends on the data itself, the method according to some example embodiments may result in better reliability of transmission of data (in certain cases) compared to the conventional methods.

Main features of methods according to some example embodiments may be one or more of the following:
Based on the desired level of privacy, the transmitter introduces a time offset (deterministic or random) to the signal corresponding to the input bit streams.
This, in turn, results in ISI at the receiver side, which serves to protect the privacy.
The proposed method is robust against A) non-linearities of the RF amplifiers and B) insufficient additive noise of the channel.
Finally, the asymmetry of the ISI contributes to the reliability of the transmission.

Typically, the method is applied to the uncoded input bit stream of a message. However, in some example embodiments, the symbols may be encoded symbol-by-symbol, for example by a Hamming code.

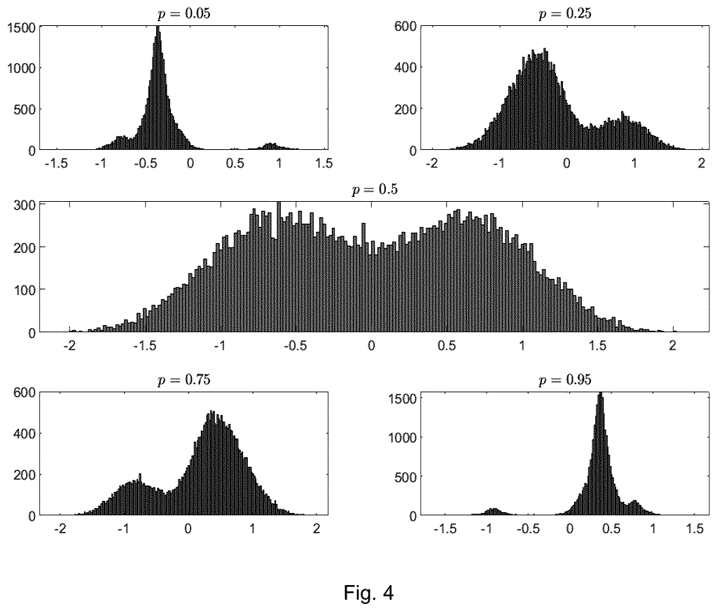

Now, methods according to some example embodiments are explained at greater detail with reference to FIGS. 4 to 9.

Assume that in a band-limited AWGN channel, the transmitter introduces a time offset in the transmission of a signal. As a result, the baseband signal is given by

$$X ( t ) = {\sum }_{n = - ∞}^{+ ∞} {B}_{n} g ( t - nT - τ T )$$

where {Bₙ} denotes the i.i.d. (uncoded) binary message sequence distributed according to Bernoulli distribution Bern(p), i.e., Pr{Bₙ=1}=1−Pr{Bₙ=−1}=p, and g(.) denotes the band-limited pulse shape. The term τT with τ∈]0,1 [(i.e. larger than 0 and smaller than 1; 0 and 1 excluded) is a time offset deliberately introduced at the transmitter to produce ISI at the receiver. The receiver, unaware of the time offset and resulting ISI, samples the received signal every T seconds to produce the input of the decoder as

$${Y}_{i} = g ( - τ T ) {B}_{i} + {\sum }_{n \neq i} {B}_{n} g ( ( i - n - τ ) T ) + {N}_{i} , ∀ i$$

For the ease of readability, and without any loss in the validity of our results, T=1 is assumed from now on.

With the knowledge of p, the optimal decoder, unaware of the ISI, is the maximum a posteriori (MAP) detector, where the optimality is in terms of minimizing the probability of error. Without the knowledge of p, which is the case here (since differential privacy is a distribution-agnostic context), it is easy to verify that the optimal detector is the minimum distance decoder, which is identical to maximum likelihood (ML) detection, where the optimality is in the best-worst sense, i.e., it minimizes (over the space of decoders) the maximum (over p) of the error probability. Therefore, with minimum distance detection, the worst probability of error is minimized.

In the ideal band-limited scenario, g(t)=\sqrt{SNR}·sinc(t) and normalizing the noise variance to 1, SNR denotes the transmitted power. Since sinc is an even function, and the analysis of Yᵢ is the same across all i, one may focus on

$${Y}_{0} = {g}_{0} {B}_{0} + {\sum }_{n \neq 0} {g}_{n} {B}_{n} + N$$

where gₙ=\sqrt{SNR}·sinc(n+τ), N~N(0,1), and the decoder votes for [symbol] =1 if Y₀≥0, and [symbol] =−1, otherwise.

Prior to the analysis of the privacy by ISI (abbreviated as PISI), we first consider the ISI-free case, i.e., τ=0, as a benchmark for comparison as follows.

In this case, Y₀=g₀B₀+N, and the transition from B₀ to [symbol] follows that of a binary symmetric channel (BSC) with crossover probability of Q(SNR) with

$$Q ( x ) = \frac{1}{\sqrt{2 π}} {\int }_{x}^{+ ∞} {e}^{- \frac{{u}^{2}}{2}} du .$$

This BSC otters the privacy loss of

$$ϵ = ln \frac{1 - Q ( \sqrt{SNR} )}{Q ( \sqrt{SNR} )} .$$

If this value falls below the desired level of privacy ϵ₀, the transmission is deemed private, otherwise, privacy should be enhanced. Obviously, one may always reduce the SNR to achieve ϵ being smaller than ϵ₀. However, this procedure has one practical shortcoming, which is related to the dynamic range of the RF amplifiers. At low signal levels, they have non-linearity and distortion in the signal. In other words, in the high privacy regime (i.e., small ϵ.), the SNR must be lowered to a low level, and as a result, the input power of the signal might be lower (or even much lower) than the operating range of the RF amplifier causing corruption in the signal. For instance, if the channel itself is in good condition (i.e., very low noise variance), even normal ranges of ϵ might be impractical with this conventional method. For comparison purposes, this conventional method is called privacy by SNR (or PSNR in short).

Now, the analysis of PISI, i.e., τ≠0, is continued. In some example embodiments, the ISI term Σ_{n≠0} gₙBₙ is utilized for the preservation of privacy. As a result, its random behavior is of crucial importance for the analysis of privacy.

In FIG. 4, a visual representation of the distribution of the ISI is provided for various values of the input parameter p describing the Bernoulli distribution. More specifically, they show the histogram of 30000 realizations of

$${\sum }_{n = - 1 \; 000 , n \neq 0}^{1000} {g}_{n} {B}_{n}$$

with SNR=1 and

$$τ = \frac{1}{2} .$$

It can be shown that the following equalities apply:

$$m {=}^{Δ} {\sum }_{n \neq 0} {g}_{n} = \sqrt{SNR} ( 1 - sin c ( τ ) )$$

$$V {=}^{Δ} {\sum }_{n \neq 0} {g}_{n}^{2} = SNR ( 1 - sin {c}^{2} ( τ ) )$$

Although the distribution of ISI is not known in closed-form, it can be shown that its distribution around its mean is sub-Gaussian (the mean is (2p−1)m and variance 4p(1−p)V), and it admits a smooth probability density function (pdf) with the whole real line as its support when p,τ∈(0,1).

From the plots in FIG. 4, one may observe that the more p deviates from

$$\frac{1}{2} ,$$

the more asymmetric the distribution of the ISI becomes, and for the extremes of p=0 or p=1, it becomes a single mass point at −m, or m, respectively.

As mentioned earlier, the decoder at the receiver, unaware of the ISI, votes for [symbol] =1 if Y₀≥0, and [symbol] =−1, otherwise. Due to the asymmetry in the ISI distribution in general, the transition from B₀ to [symbol] is a Binary Asymmetric Channel (BAC) with crossover probabilities given by

$${p}_{- 1} = Pr \{ \hat{{B}_{0}} = 1 \vert {B}_{0} = - 1 \} = Pr \{ A + N \geq {g}_{0} \}$$

$${p}_{1} = Pr \{ \hat{{B}_{0}} = - 1 \vert {B}_{0} = 1 \} = Pr \{ A + N \leq - {g}_{0} \}$$

where the probabilities are taken over the randomness of the ISI (A) and the Gaussian noise (N). Since the distribution of A is unknown in general, analytical evaluation of p₋₁ and p₁ is challenging. Nonetheless, there is the following interesting observation on how ISI introduces error in this BAC: The more (less) the probability of a mass point, the less (more) noise it encounters. For instance, if the probability of mass point +1, which is denoted by p, is increased, the error it encounters, i.e., p₁, decreases. This can also be verified from the plots in FIG. 4. By increasing p, the distribution of ISI shifts to the right on the abscissa, and hence, Pr{A+N≤−g₀} (which is p₁) decreases. This asymmetric data-dependence of the ISI will be used later in the discussion of the average probability of error.

This BAC provides e-differential privacy for each input bits, with ϵ given by

$$ϵ = ln max \{ \frac{{p}_{1}}{1 - {p}_{- 1}} , \frac{1 - {p}_{- 1}}{{p}_{1}} , \frac{{p}_{- 1}}{1 - {p}_{1}} , \frac{1 - {p}_{1}}{{p}_{- 1}} \} = ln \frac{1 - max \{ {p}_{1} , {p}_{- 1} \}}{min \{ {p}_{1} , {p}_{- 1} \}}$$

where the last equality follows from p₁+p₋₁≤1. Obviously, exchanging p₁ and p₋₁ does not affect ϵ. Moreover, since this exchange is equivalent to replacing p with 1−p, we conclude that ϵ depends on p only through

$$\vert p - \frac{1}{2} \vert ,$$

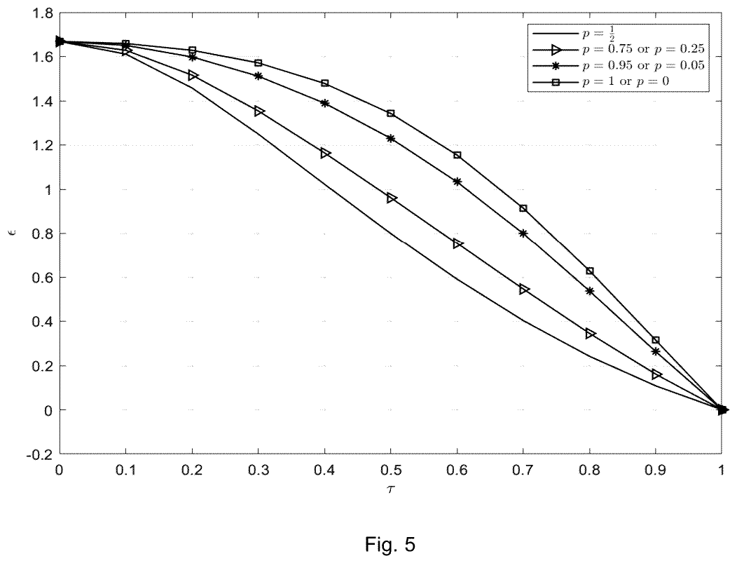

i.e., It is symmetric around 0.5. FIG. 5 shows the privacy level of this BAC as a function of the time offset τ∈[0,1] for various values of p at SNR=0 dB.

At τ=0, i.e., no time offset, there is no ISI, since gₙ=0, ∀n≠0, and we have Y₀=B₀+N. As a result, the transition from B₀
to [symbol] is a binary symmetric channel (BSC) with crossover probability p₁=p₋₁=Q(\sqrt{SNR}), and the privacy level

$$( i . e . , ϵ = ln \frac{1 - Q ( \sqrt{SNR} )}{Q ( \sqrt{SNR} )} )$$

is purely offered by the additive Gaussian noise. At the other extreme, i.e., τ=1, we have g₀=0, and Y₀ becomes statistically independent of B₀ resulting in ϵ=0.

Although from the plots in FIG. 5, for any p, we can find the value of the time offset τ to result in a desired level of ϵ, this value depends on the input distribution (here, p). However, in the context of differential privacy, typically one does not know the input distribution (here, p), and the achieved privacy level should not depend on the input distribution. In other words, a differentially private mechanism must protect privacy regardless of the input statistics. Therefore, one may select the time offset according to the worst-case scenario, i.e., the curve corresponding to p=1(p=0). By doing so, it is guaranteed that regardless of the input distribution, the desired level of privacy is satisfied. Fortunately, this worst-case ϵ has a closed-form representation given by

$${ϵ}_{w} = ln \frac{Q ( \sqrt{SNR} ( 1 - 2 sin c ( τ ) ) )}{Q ( \sqrt{SNR} )}$$

and setting ϵ_{w} equal to the desired ϵ_{θ}, τ can be obtained as

$$τ = sin {c}^{- 1} ( \frac{1}{2} ( 1 - \frac{{Q}^{- 1} ( {e}^{ϵ} Q ( \sqrt{SNR} ) )}{\sqrt{SNR}} ) )$$

where the range of the inverse sinc function is [0,1] and the effective range of ∈ is

$$[ 0 , ln \frac{1 - Q ( \sqrt{SNR} )}{Q ( \sqrt{SNR} )} ]$$

with the upper limit attained by no ISI. For some example embodiments of the invention, the values of 0 and 1 are excluded for τ. FIG. 6 shows the curves of the above equation for two values of SNR (0 dB and 10 dB).

The two privacy-preserving mechanisms PISI according to some example embodiments and conventional PSNR are compared in terms of the utility they provide. Thus, it is shown that PISI does not guarantee perfect privacy at the expense of killing the utility. The utility is given by a measurement how low the average bit error probability in each of these mechanisms is.

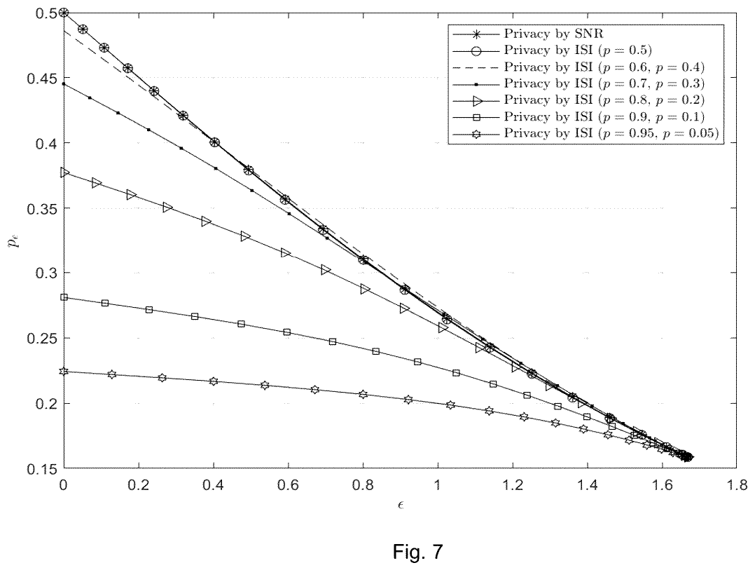

In FIG. 7, several plots of the utility p_{c} vs. the achieved privacy ϵ are provided for PSNR and PISI with different distributions of symbols, expressed by the value of p in the Bernoulli distribution. For each of the mechanisms, the utility is measured by how low the average bit error probability in the respective mechanism is. These plots show the following:

In PSNR, the average probability of error is Q(\sqrt{SNR}) with

$$ϵ = ln \frac{1 - Q ( \sqrt{SNR} )}{Q ( \sqrt{SNR} )} .$$

By sweeping SNR from 1 (0 dB) to 0 (−¢ dB, at least possible in theory), one gets the curve of PSNR.

The curves that correspond to PISI are plotted by sweeping the time offset τ from 0 to 1 (corresponds to sweeping e, as shown in FIG. 5) at SNR=0 dB for various input distributions, which, as stated before, are symmetric around p=0.5.

One can see that ISI makes the transmission less reliable by increasing the error probability, which is an undesirable phenomenon from a conventional viewpoint, i.e., when privacy is not a concern. Furthermore, we observe that the more asymmetric the input distribution is, the better utility is provided in PISI, which is in line with the aforementioned fact that ISI introduces low error to the high probable input, making the average error probability smaller. However, a note of caution is given in terms of how to compare the two methods PISI and PSNR. Although the curves of the trade-off (between utility and privacy) in PISI seem to be superior to that in PSNR in most cases, one cannot conclude that “In most cases, for a given desired E, PISI provides better utility compared to PSNR.” A correct statement would rather be “If both schemes result in the same level of privacy, the utility of PISI is better than that of PSNR in most cases.”. The reason is that, since the input distribution p is not known, to satisfy the privacy requirement of ϵ₀, one selects the time offset τ according to the worst possible input (i.e., p=1 or p=0) as stated before for some example embodiments. However, this selected value of time offset results in ϵ<ϵ₀, if p≠1, which is a better privacy protection than required, but possibly at the cost of a utility being worse than that obtained via PSNR at ϵ=ϵ₀.

As an example, assume that ϵ₀=0.5. In PSNR, setting SNR=−10 dB attains this privacy loss, and the corresponding utility is pₑ=0.376. In PISI, we get τ=0.8414 according to the equation mentioned before, which guarantees that the privacy loss is kept below ϵ₀=0.5, regardless of the input distribution p. Now, the actual level of the privacy loss depends on the input distribution: if p=0.5, we get ϵ=0.1824 with pₑ=0.4545. In this case, PISI is better than PSNR in terms of privacy, but worse in terms of utility. If, however, p=0.8, PISI results in ϵ=0.29 with pₑ=0.35, which is better than PSNR in both metrics. In summary, ignoring the practical issue of PSNR at low SNR values due to the dynamic range of RF amplifiers, PSNR provides privacy by introducing error in a symmetric way, while PISI does it in an asymmetric manner.

Thus far, it is assumed that the receiver is not aware of the time offset τ introduced by the transmitter. Now let's assume that the receiver is informed somehow about the value of the time offset. As a result, the sampling at the receiver can shift with the same time offset, and the ISI disappears.

To tackle this potential privacy issue, the transmitter according to some example embodiments introduces a random time offset τ in the interval]0,1 [(larger than 0 and smaller than 1, 0 and 1 excluded). The received signal is the same as the previous section with the difference that τ is now a random variable in]0,1[. Thus, the receiver does not know the time offset and, hence, cannot compensate the time offset such that ISI occurs at the receiver.

To give an example, τ may follow the beta distribution, which is a family of continuous probability distributions defined on the interval [0, 1], in terms of two positive parameters α, β with the following pdf

$$f ( x ) = \frac{Γ ( α + β )}{Γ ( α ) Γ ( β )} {{x}^{α - 1} ( 1 - x )}^{β - 1} , x ∈ [ 0 , 1 ]$$

where Γ(⋅) denotes the Gamma function. For some example embodiments, the values 0 and 1 are excluded.

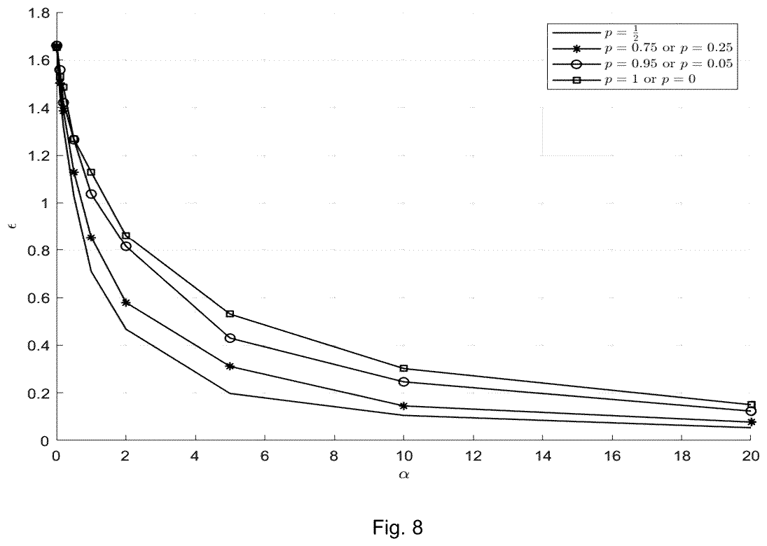

The reason for selection of this distribution in some example embodiments is as follows. By setting β=1, one may tune α∈(0, +¢) to sweep from one extreme τ=0 to the other, i.e., τ=1. More specifically, the pdf gets closer to a single mass point at 0, when α→0, it becomes uniform with α=1, and it gets closer to a single mass point at 1, when α→+∞. As a result, by tuning α, one may expect a similar behavior of ϵ as in the previous section with deterministic τ. This is verified in FIG. 8. FIG. 8 shows the achieved privacy loss ϵ vs. the tuning parameter α at SNR=0 dB.

Like in the above described case where τ is determined in a deterministic way, one may select α for the desired privacy loss ϵ from the worst-case scenario, i.e., p=0 or p=1. In contrast to the previous section, a closed-form representation for this curve is not known. However, in some example embodiments, α may be selected by a numerical calculation or from a lookup table.

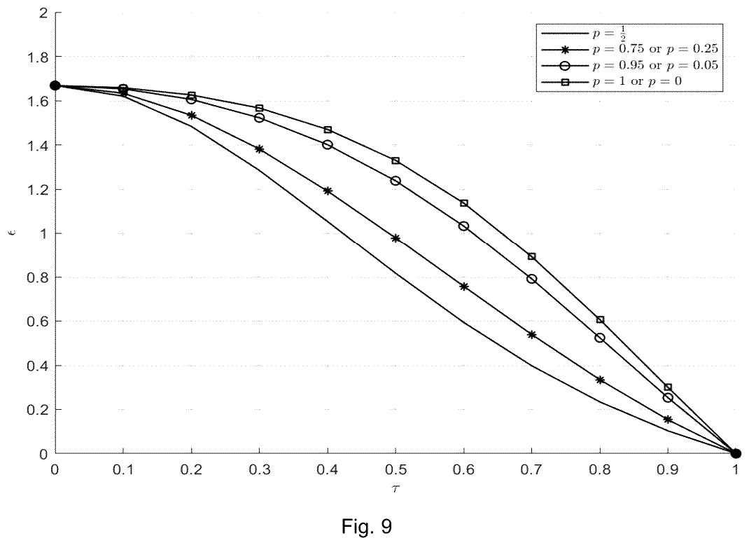

Thus far, the analysis is based on the ideal pulse shaping, i.e., the sinc pulse. The analysis, however, can be generalized to more practical pulse shapes, such as the most common pulse shaping, which is the root-raised-cosine (RRC) pulse. At the transmitter, there is an RRC filter, and similarly, at the receiver side, there is an RRC matched filter. As a result, the output of the matched filter is a raised cosine (RC) pulse, since the combined effect of two RRC filters becomes RC. Therefore, the received signal is Y₀=g₀B₀+Σ_{n≠0}gₙ Bₙ+N, with gₙ=\sqrt{SNR}h_{RC}(n+τ). where h_{RC}(⋅) denotes the impulse response of the raised cosine filter. FIG. 9 shows the achieved privacy loss ϵ vs. τ for the RRC pulse shape with SNR=0 dB. The curves in FIG. 9 are quite similar to those of FIG. 5. In the same way as discussed with respect to FIG. 5, in FIG. 9 one may select τ for a desired value of ϵ from the curve of the worst case, i.e. p=1 or p=0.

Example embodiments may not only be applied to binary messages but to larger alphabets, too. One may obtain the curves of privacy loss vs. the time offset for different input distributions, and pick the worst case as the criterion of selection of the time offset for a given privacy level.

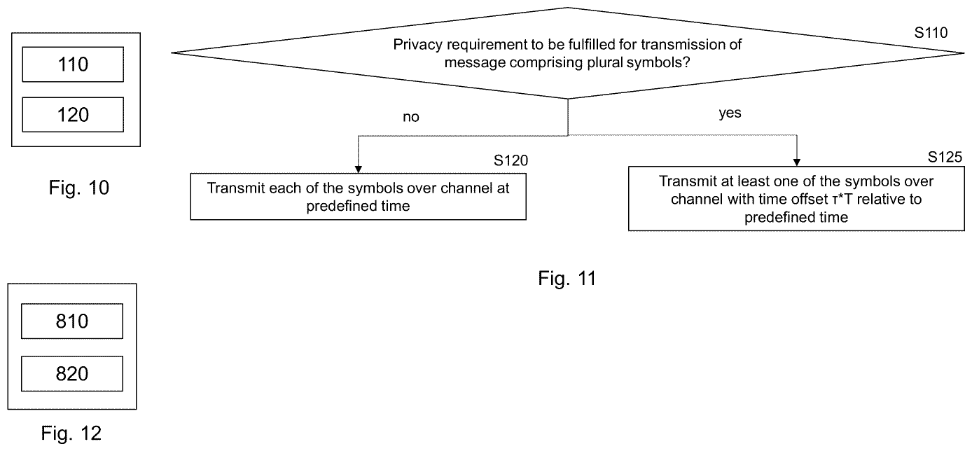

FIG. 10 shows an apparatus according to an example embodiment. The apparatus may be a device participating in a voting or an element thereof. FIG. 11 shows a method according to an example embodiment. The apparatus according to FIG. 10 may perform the method of FIG. 11 but is not limited to this method. The method of FIG. 11 may be performed by the apparatus of FIG. 10 but is not limited to being performed by this apparatus.

The apparatus comprises means for checking 110 and means for transmitting 120. The means for checking 110 and means for transmitting 120 may be a checking means and transmission means, respectively. The means for checking 110 and means for transmitting 120 may be a checker and a transmitter, respectively. The means for checking 110 and means for transmitting 120 may be a checking processor and transmitting processor, respectively.

The means for checking 110 checks if a privacy requirement has to be fulfilled for a transmission of a message on a channel (S110). The message comprises plural symbols.

In response to checking that the privacy requirement has not to be fulfilled (S110=no), the means for transmitting 120 transmits each of the symbols of the message over the channel at a respective time according to a predefined timing (S120). The predefined timing may be a conventional timing.

In response to checking that the privacy requirement has to be fulfilled (S110=yes), the means for transmitting 120 is configured to transmit at least one of the symbols of the message over the channel with a respective time offset τ*T relative to the respective predefined time (S125). T is a time delay between transmissions of subsequent symbols of the message on the channel according to the predefined timing. τ is larger than 0 and smaller than 1. In some example embodiments, the lower limit of the value of τ may be 0.01, or 0.05, or 0.1. In some example embodiments, the upper limit of the value of τ may be 0.99, or 0.95, or 0.9.

FIG. 12 shows an apparatus according to an example embodiment. The apparatus comprises at least one processor 810, at least one memory 820 storing instructions that, when executed by the at least one processor 810, cause the apparatus at least to perform the method according to FIG. 11 and related description.

Example embodiments may be applied to transmitters of arbitrary communication networks including wired communication networks or wireless communication networks, such as 3GPP networks of any generation (4G, 5G, 6G, 7G, for example).

It is preferred that each of the communications between the different entities is performed in a secure way, e.g. by tunneling and/or encrypting etc.

One piece of information may be transmitted in one or plural messages from one entity to another entity. Each of these messages may comprise further (different) pieces of information.

Names of network elements, network functions, protocols, and methods are based on current standards, or are current proposals. These names are not limiting. For example, in other versions or other technologies, the names of corresponding entities may be different or the same as in the present description.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be deployed in the cloud.

According to the above description, it should thus be apparent that example embodiments provide, for example, a transmitter or an element thereof, an apparatus embodying the same, a method for controlling and/or operating the same, and computer program(s) controlling and/or operating the same as well as mediums carrying such computer program(s) and forming computer program product(s).

Implementations of any of the above-described blocks, apparatuses, systems, techniques or methods include, as non-limiting examples, implementations as hardware, software, firmware, special purpose circuits or logic, general purpose hardware or controller or other computing devices, or some combination thereof. Each of the entities described in the present description may be embodied in the cloud.

It is to be understood that what is described above is what is presently considered the preferred example embodiments. However, it should be noted that the description of the preferred example embodiments is given by way of example only and that various modifications may be made without departing from the scope of the disclosure as defined by the appended claims.

The terms “first X” and “second X” include the options that “first X” is the same as “second X” and that “first X” is different from “second X”, unless otherwise specified. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. The term “or” refers to a non-exclusive “or” unless otherwise indicated (e.g., use of “or else” or “or in the alternative”).

1. An apparatus comprising:
at least one processor and
at least one memory storing instructions that, when executed by the at least one processor, cause the apparatus at least to perform
checking if a privacy requirement has to be fulfilled for a transmission of a message comprising plural symbols on a channel;
transmitting each of the symbols of the message over the channel at a respective time according to a predefined timing in response to checking that the privacy requirement has not to be fulfilled or
transmitting at least one of the symbols of the message over the channel with a respective time offset τ*T relative to the respective predefined time in response to checking that the privacy requirement has to be fulfilled, wherein
T is a time delay between transmissions of subsequent symbols of the message on the channel according to the predefined timing, and
τ is larger than 0 and smaller than 1.

2. The apparatus according to claim 1, wherein τ is equal to or larger than 0.01 and equal to or smaller than 0.99.

3. The apparatus according to claim 1, wherein
$$τ = sin {c}^{- 1} ( \frac{1}{2} ( 1 - \frac{{Q}^{- 1} ( {e}^{{ϵ}_{0}} Q ( \sqrt{SNR} ) )}{\sqrt{SNR}} ) ) ,$$
e is the Napier number, ϵ₀ denotes the privacy requirement, SNR denotes the signal-to-noise ratio of the channel, and Q(\sqrt{SNR}) is a crossover probability of the channel at the signal to noise ratio SNR.

4. The apparatus according to claim 1, wherein the apparatus is further caused to perform
transmitting each of the symbols of the message over the channel with a respective time offset τ*T relative to the respective predefined time in response to checking that the privacy requirement has to be fulfilled.

5. The apparatus according to claim 4, wherein τ has a same value for the transmission of each of the symbols of the message.

6. The apparatus according to claim 4, wherein the apparatus is further caused to perform
determining, for each of the symbols of the message, a respective value of τ by a random function.

7. The apparatus according to claim 6, wherein the random function has a probability distribution such that the privacy requirement is fulfilled for every arbitrary distribution of values of the symbols of the message.

8. The apparatus according to claim 1, wherein the apparatus is further caused to perform
inhibiting encoding of the symbols for the transmission of the symbols on the channel.

9. The apparatus according to claim 1, wherein the apparatus is further caused to perform
encoding the symbols symbol-per-symbol for the transmission of the symbols on the channel.

10. A method comprising:
checking if a privacy requirement has to be fulfilled for a transmission of a message comprising plural symbols on a channel;
transmitting each of the symbols of the message over the channel at a respective time according to a predefined timing in response to checking that the privacy requirement has not to be fulfilled or
transmitting at least one of the symbols of the message over the channel with a respective time offset τ*T relative to the respective predefined time in response to checking that the privacy requirement has to be fulfilled, wherein
T is a time delay between transmissions of subsequent symbols of the message on the channel according to the predefined timing and
τ is larger than 0 and smaller than 1.

11. The method according to claim 10, wherein τ is equal to or larger than 0.01 and equal to or smaller than 0.99.

12. The method according to claim 10, wherein
$$τ = sin {c}^{- 1} ( \frac{1}{2} ( 1 - \frac{{Q}^{- 1} ( {e}^{{ϵ}_{0}} Q ( \sqrt{SNR} ) )}{\sqrt{SNR}} ) ) ,$$
e is the Napier number, ϵ₀ denotes the privacy requirement, SNR denotes the signal-to-noise ratio of the channel, and Q(\sqrt{SNR}) is a crossover probability of the channel at the signal to noise ratio SNR.

13. The method according to claim 10, further comprising
transmitting each of the symbols of the message over the channel with a respective time offset τ*T relative to the respective predefined time in response to checking that the privacy requirement has to be fulfilled.

14. The method according to claim 13, wherein τ has a same value for the transmission of each of the symbols of the message.

15. The method according to claim 13, further comprising
determining, for each of the symbols of the message, a respective value of τ by a random function.

16. The method according to claim 15, wherein the random function has a probability distribution such that the privacy requirement is fulfilled for every arbitrary distribution of values of the symbols of the message.

17. The method according to claim 10, further comprising
inhibiting encoding of the symbols for the transmission of the symbols on the channel.

18. The method according to claim 10, further comprising
encoding the symbols symbol-per-symbol for the transmission of the symbols on the channel.
